(19) United States
(12) Patent Application Publication
(10) Pub. No.: US 2026/0158676 A1
(43) Pub. Date: Jun. 11, 2026

(54) METHOD FOR POSITIONING MOBILE ROBOT IN ENVIRONMENT AND ITS ASSOCIATED ROBOT SYSTEM

(71) Applicant: ABB SCHWEIZ AG, Baden (CH)

(72) Inventors: Chenlu Wan, Ningbo (CN); You Wu, Shanghai (CN)

(21) Appl. No.: 19/465,546

(22) Filed: Jan. 30, 2026

Related U.S. Application Data
(63) Continuation of application No. PCT/CN2023/110252, filed on Jul. 31, 2023.

(51) Int. Cl. B25J 13/08; B25J 9/16

(52) U.S. Cl. CPC B25J 13/089; B25J 9/1607; B25J 9/1653; B25J 9/1694

(57) ABSTRACT

A method for positioning a mobile robot in an environment, in which a plurality of RFID tags are arranged, includes receiving one or more RF signals from at least one RFID tag among the plurality of RFID tags via a RFID reader arranged on the mobile robot; estimating a first position of the robot in the environment based on the received one or more RF signals; obtaining inertial data from an inertial measurement unit (IMU) arranged on the robot; estimating a second position of the robot based the inertial data; and determining a calibrated position of the robot based on the first position and the second position.

### FIELD OF THE INVENTION

This invention relates to a robot technique, and, more particularly, to a method for positioning a mobile robot in an environment and its associated robot system.

### BACKGROUND OF THE INVENTION

In modern supply management systems, AMRs (Autonomous Mobile Robots) are more and more widely used.

In catering industry, AMRs are increasingly popular to be applied to implement loading and unloading dishes. In several projects, an AMR may serve as a “waiter” in the restaurants for serving. The positioning or navigation method for AMRs is laser-based SLAM, which means that the AMRs detect the surroundings and implement positioning based on the laser radar.

### SUMMARY OF THE INVENTION

The invention is defined by the claims.

According to one aspect of the disclosure, there is provided a method for positioning a mobile robot in an environment, in which a plurality of RFID tags are arranged, the method comprising: receiving one or more RF signals from at least one RFID tag among the plurality of RFID tags via a RFID reader arranged on the mobile robot; estimating a first position of the robot in the environment based on the received one or more RF signals; obtaining inertial data from an inertial measurement unit (IMU) arranged on the robot; estimating a second position of the robot based the inertial data; and determining a calibrated position of the robot based on the first positon and the second position.

In some embodiments, the method further comprises: obtaining wheel odometry data from a wheel odometry unit integrated with the robot, the wheel odometry data including a velocity information and a pose information of the robot.

In some embodiments, the determining the calibrated position of the robot comprises: determining the calibrated position of the robot based on the first positon, the second position and the wheel odometry data.

In some embodiments, the method further comprises: estimating a first velocity and a first orientation of the robot in the environment based on said inertial data; determining a calibrated velocity based on the first velocity and the velocity information; and determining a calibrated orientation based on the first orientation and the pose information.

In some embodiments, the obtaining inertial data from an inertial measurement unit (IMU) arranged on the robot comprises: deriving a corrected first velocity of the robot by compensating an acceleration error, which is determined by applying a zero acceleration and a zero velocity to the robot; and deriving a corrected angular rate of the robot by compensating an angular rate error, which is determined by applying a zero angular rate to the robot.

In some embodiments, the determining the calibrated position of the robot is performed by a data fusing engine.

In some embodiments, the data fusing engine comprises any one selected from a group comprising a Kalman Filter (KF), an Extended Kalman Filter (EKF), a Complementary Kalman Filter, and an Error-state Extended Kalman Filter (ES-EKF).

In some embodiments, the estimating a first position of the robot in the environment comprises: estimating the first position based on the signal strength data of the received one or more RF signals.

In some embodiments, the estimating the first position based on the signal strength data of the received one or more RF signals comprises: using an established probabilistic sensor model to derive a modified signal strength data, wherein the established probabilistic sensor model defines a probability distribution of signal strength data across the environment; and estimating the first position based on the modified signal strength data.

In some embodiments, the using an established probabilistic sensor model to derive a modified signal strength data comprises: calculating a RSS mean value based on the signal strength data received within a set time period; using the established probabilistic sensor model to obtain a probability related to said RSS mean value; and multiplying the RSS mean value with the probability to derive the modified signal strength data.

In some embodiments, the estimating the first position based on the modified signal strength data comprises: using the modified signal strength data as an input for a RSSI distance model to derive the first position.

In some embodiments, the RFID tags are ultra high frequency (UHF) passive RFID tags. In some embodiments, the plurality of RFID tags are arranged in an array or a grid pattern. In some embodiments, the plurality of RFID tags are evenly distributed across the environment.

According to another aspect of the disclosure, there is provided a mobile robot system comprising: a mobile robot having an inertial measurement unit (IMU) and configured to move in an environment provided with a plurality of RFID tags; a RFID reader arranged on the robot; and a controller integrated or associated with the robot, wherein the controller is configured to: receive one or more RF signals from at least one RFID tag among the plurality of RFID tags via the RFID reader; estimate a first position of the robot in the environment based on the received one or more RF signals; obtain inertial data from the inertial measurement unit (IMU); estimate a second position of the robot based on the inertial data; and determine a calibrated position of the robot based on the first positon and the second position.

According to yet another aspect of the disclosure, there is provided a method for positioning a mobile robot in an environment, in which a plurality of RFID tags are arranged, the method comprising: receiving one or more RF signals from at least one RFID tag among the plurality of RFID tags via a RFID reader arranged on the mobile robot; using signal strength data of the received one or more RF signals as an input for an established probabilistic sensor model to derive a modified signal strength data, wherein the established probabilistic sensor model defines a probability distribution of signal strength data across the environment; determining a first position of the robot in the environment based on said modified signal strength data.

In some embodiments, the using the signal strength data of the received one or more RF signals as an input for an established probabilistic sensor model to derive a modified signal strength data comprises: obtaining a probability related to the signal strength data of the received one or more RF signals; and deriving the modified signal strength data by multiplying the signal strength data with the probability.

In some embodiments, the determining a first position of the robot in the environment based on said modified signal strength data comprises: using the modified signal strength data as an input for a RSSI distance model to derive the first position.

According to yet another aspect of the disclosure, there is provided a robot system comprising: a robot having an inertial measurement unit (IMU) and configured to move in an environment provided with a plurality of RFID tags; a RFID reader arranged on the robot; and a controller integrated or associated with the robot, wherein the controller is configured to receive one or more RF signals from at least one RFID tag among the plurality of RFID tags via a RFID reader arranged on the mobile robot; use signal strength data of the received one or more RF signals as an input for an established probabilistic sensor model to derive a modified signal strength data, wherein the established probabilistic sensor model defines a probability distribution of signal strength data across the environment; and determine a first position of the robot in the environment based on said modified signal strength data.

According to yet another aspect of the disclosure, there is provided a computer readable medium having a computer program stored thereon which, when executed by a processor, implements the method as described above.

### BRIEF DESCRIPTION OF THE DRAWINGS

In the drawings, similar/same reference signs throughout different views generally represent similar/same parts. Drawings are not necessarily on scale. Rather, emphasis is placed upon the illustration of the principles of the present invention. In these drawings:

FIG. 1 illustrates a schematic diagram of an architecture of a mobile robot system that is capable to adopt a method for positioning a mobile robot in an environment according to one embodiment of the present disclosure;

FIG. 2 illustrates a schematic diagram of an exemplary arrangement of a plurality of UHF RFID tags according to one embodiment of the present disclosure;

FIG. 3 illustrates a detailed functional block diagram of the robot system using a data fusion technique according to one embodiment of the present disclosure;

FIG. 4 illustrates a flowchart of a method for positioning a mobile robot in an environment according to one embodiment of the present disclosure; and

FIG. 5 illustrates a flowchart of a method for positioning a mobile robot in an environment according to another embodiment of the present disclosure.

### DETAILED DESCRIPTION OF THE EMBODIMENTS

Embodiments of the present disclosure will be described in more details with reference to the drawings. Although the drawings illustrate some embodiments of the present disclosure, it should be appreciated that the present disclosure can be implemented in various manners and should not be interpreted as being limited to the embodiments explained herein. On the contrary, the embodiments are provided to understand the present disclosure in a more thorough and complete way. It should be appreciated that drawings and embodiments of the present disclosure are only for exemplary purposes rather than restricting the protection scope of the present disclosure.

In the descriptions of the embodiments of the present disclosure, the term “includes” and its variants are to be read as open-ended terms that mean “includes, but is not limited to.” The term “based on” is to be read as “based at least in part on.” The terms “one embodiment” and “this embodiment” are to be read as “at least one embodiment.” The following text also can comprise other explicit and implicit definitions.

As stated above, AMRs are increasingly popular to be applied to implement loading and unloading dishes in catering industry. However, in the catering scenarios, the laser radar is very likely to be blocked by the customers passing by, leading to a failed positioning of the robot and low working efficiency.

In order to solve the above problem, a concept of positioning a mobile robot in an environment in which a plurality of RFID tags are arranged is proposed. With the aid of the plurality of RFID tags, the positioning or navigation of the mobile robot can thus be at least based on RF signals from the at least one RFID tag among the plurality of RFID tags, which can reduce the risk of failure to position the mobile robot and improves the stability and reliability of the localization.

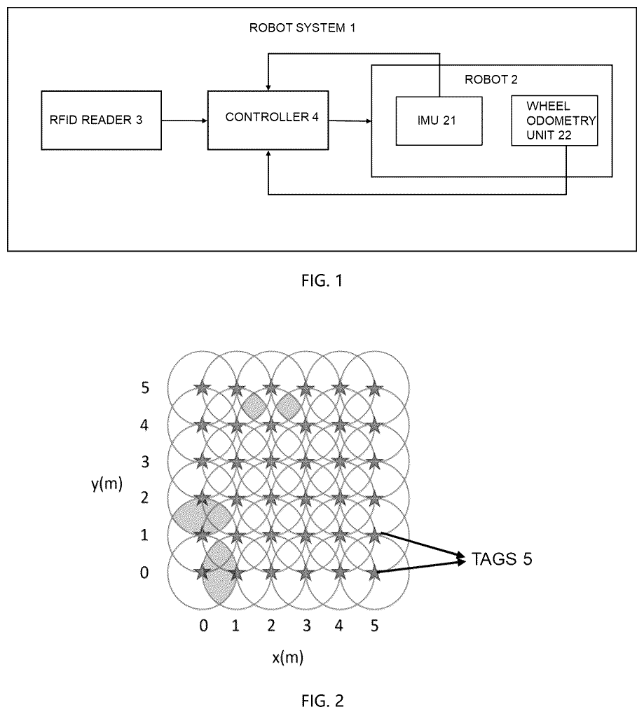

For better understanding of the above concept, FIG. 1 illustrates a schematic diagram of an architecture of a mobile robot system that is capable to adopt a method for positioning a mobile robot in an environment according to one embodiment of the present disclosure.

As shown in FIG. 1, a mobile robot system 1 may comprise at least a mobile robot 2, a RFID reader 3, and a controller 4.

In accordance with the present disclosure, the mobile robot 2 is configured to move in an environment to implement some tasks. Just as an example, the environment may be a working space in a restaurant, an office, a factory, etc.

In some embodiments, the mobile robot 2 may be an Autonomous Mobile Robot (AMR). In an environment such as a working space in a restaurant, the mobile robot 2 may for example serve as a “waiter” to load and unload dishes for customers.

To facilitate the positioning or navigation of the mobile robot 2, in the context of the present application, the environment is arranged with a plurality of RFID tags (not shown in FIG. 1).

In the present disclosure, RFID tags may be configured in a shape and size appropriate for its application scenarios. In addition, RFID tags may be active, passive or semi-passive, as desired.

Active RFID tags may include an internal battery used to transmit data and typically include the ability to read and write greater amounts of stored data than either passive or semi-passive tags. Passive RFID tags may transmit by reflecting and absorbing energy from the RF transmissions from the reader, and use absorbed energy from the reader for data storage, retrieval, and manipulation. Semi-passive tags may include an internal battery that is used for data storage, retrieval, and manipulation, and transmit data by reflecting and absorbing energy from the reader. Passive and semi-passive tags are typically lighter and less expensive than active tags. Passive tags offer a virtually unlimited operational lifetime because they do not require a battery for operation. The trade-off is that they typically have a shorter read range than active tags, and require a higher output power from the reader. It is important to note that governmental restrictions in many jurisdictions may restrict reader output power to ensure safety and to minimize interference between devices that must share frequency bands.

In some embodiments, the plurality of RFID tags may be distributed in any desired pattern in the environment. In some embodiments, the plurality of RFID tags may be arranged in an array. In some embodiments, the plurality of RFID tags may be arranged in a grid pattern. In some embodiments, the plurality of RFID tags may be evenly distributed across the environment. In some embodiments, part or most or all of the plurality of RFID tags may be arranged at an equal height with respect to the ground.

Those skilled in the art would appreciate that a regular pattern (e.g., a grid pattern) for arranging the plurality of the RFID tags will be advantageous in reducing the complexity of positioning of the mobile robot as compared to an irregular pattern. Also, those skilled in the art would appreciate that with the arrangement of these RFID tags, the geographical positions of these RFID tags may be regarded as known data during the positioning of the mobile robot.

For the arrangement of the plurality of RFID tags, these RFID tags may for example be attached to a ground, a pillar, a wall, a furniture etc. in the environment, as appropriate.

In some embodiments, the arrangement of a plurality of ultra high frequency (UHF) passive RFID tags may be particularly advantageous in that as compared to the low or medium frequency RFIDs, UHF passive RFID tags can be detected in a longer distance, which is typically larger than 1 m. Herein it is noted that UHF refers to about 860-960 Mhz. Typically, in such an embodiment with UHF RFIDs, the distance between neighboring RFIDs may be set as 1 m to 1.5 m.

Just as an example, FIG. 2 illustrates a schematic diagram of an exemplary arrangement of a plurality of UHF RFID tags according to one embodiment of the present disclosure.

As shown in FIG. 2, a plurality of UHF RFID tags 5 (labelled as stars) may be evenly distributed and arranged in a grid pattern, and a number of circles depicted therein can respectively represent a detecting range for each RFID tag 5. Those skilled in the art would appreciate that by designing a proper arrangement of the RFID tags, in most of the positions in the environment, at least two or more RFID tags may be detected and the geographical positions of these RFID tags may be used to aid the positioning of the robot.

A RFID reader 3 may be attached to or integrated with the robot 2. In some embodiments, the RFID reader 3 may be arranged at the same height with most or all of the RFID tags with respect to ground, which will facilitate the detection of these RFID tags.

Typically, the RFID reader 3 may include one or more antennas. In some embodiments, the RFID reader 3 may both transmit RFID tag interrogation signals and receive backscattered RF signals transmitted from RFID tags in response to the interrogation signals. In this way, the geographical positions of the detected RFID as well as the signal strength data (i.e., Received Signal Strength Indicator or RSSI) may be obtained via the RFID reader 3.

With the above geographical positions of the detected RFID and the signal strength data, the positioning of the robot can then be performed, as will be detailed thereafter.

In some embodiments, the RFID tags may further comprise information relating to movement instruction (e.g., about a moving direction) for the mobile robot 2, which may also be obtained via the RFID reader 3 and then used to guide the movement of the mobile robot 2.

The RFID reader 3 may be wiredly or wirelessly connected to a controller 4, which may be integrated or associated with the robot 2 and configured to control the RFID reader 3 and the movement of the robot 2. Typically, the information obtained via the RFID reader 3 may be transmitted to the controller 4 for further processing, e.g., localization or positioning of the robot 2 in the environment.

In some embodiments, an inertial measurement unit (IMU) 21 and/or a wheel odometry unit 22 may be mounted on or integrated with the robot 2 and configured to communicate with the controller 4 through e.g., a serial communication.

Typically, the IMU 21 may be a multi-axis IMU, e.g., a 9-axis IMU, which may comprise one or more accelerometers, one or more gyroscopes, and one or more optional magnetometers to measure inertial data including an acceleration, an angular rate and optional magnetic data. The inertial data may be communicated to the controller 4 for estimating the position, velocity, and orientation of the robot. Herein it is noted that magnetic data measured from the magnetometers may be used for providing orientation information, which may be used thereafter for reducing errors.

The wheel odometry unit 22 is typically a wheel encoder, e.g., a pulsed encoder, a single-turn absolute encoder, or a multi-turn absolute encoder, which is generally attached to the motors of the wheels to measure the wheel odometry data including e.g., a velocity information and a pose information (including position and orientation) of the robot 2. The wheel odometry data from the wheel odometry unit 22 may be communicated to the controller 4 for further processing.

In addition to the above IMU 21 and the wheel odometry unit 22, in some embodiments, other sensors including e.g., cameras, LiDARs (Light Detection and Ranging) may also be included in or integrated with the robot 2.

There are advantages or disadvantages associated with the various sensors. For example, with respect to the IMU, since the velocity and the position of the robot are obtained by integration of measured data, any drift or bias in measurement of acceleration and angular rate will cause accumulation of errors in the estimation of the velocity and position; while the wheel odometry unit generally measures the amount of the translation of the robot more accurately, as compared to the IMU.

Therefore, it might be advantageous to fuse the measurement results from various sensors so as to take advantage of each sensor.

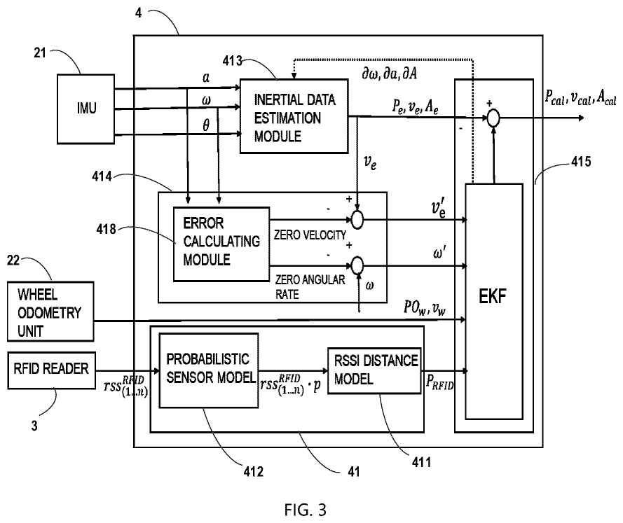

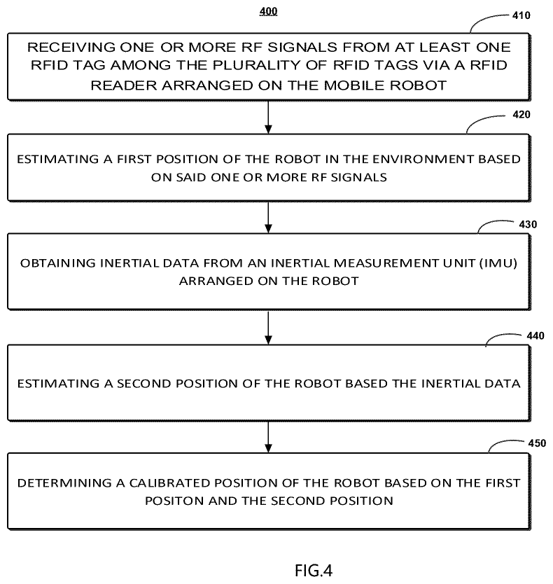

For better understanding of the data fusing method, reference may be made to FIG. 3, which illustrates a detailed functional block diagram of the robot system using a data fusion technique according to one embodiment of the present disclosure.

As shown in FIG. 3, the controller 4 may collect various measurement data from the RFID reader 3, the IMU 21 and the wheel odometry unit 22.

With respect to the processing of the measurement data from the RFID reader 3, the controller 4 may comprise a position determination module 41, which is configured to estimate a first position of the robot in the environment based on the received one or more RF signals.

In some embodiments, the estimating a first position of the robot in the environment based on the received one or more RF signals may be performed based on the signal strength data of the received one or more RF signals, i.e., Received Signal Strength Indicator (RSSI) data.

In some embodiments, the position determination module 41 may comprise merely a RSSI distance model 411 which defines a relationship between RSSI and the distance from the RFID tag.

As an example, in free space the RSSI distance model 411 may be expressed as below.

$${P}_{r} ( d ) = {P}_{t} * {G}_{t} * {G}_{r} * {( \frac{λ}{4 π d} )}^{2} \qquad ( 1 )$$

where Pr is received power at the receiving antenna of the RFID reader; Pt is transmitted power at the transmitting antenna of the RFID reader; Gt and Gr are gains of the transmitting antenna and the receiving antenna, respectively; d is the distance between the transmitting antenna and the receiving antenna, which may be transformed into a position of the robot in the environment; and λ is the transmitted wavelength.

As another example, in a non-ideal environment the RSSI distance model may be expressed below.

$$RSSI ( d ) = A - 10 * n * lg ( d ) + {X}_{σ} \qquad ( 2 )$$

where A is related to the transmitted power of the transmitting antenna; n represents the speed of signal strength attenuation under the environmental influence; and X_{σ} is a random variable caused by the environment and the distribution is obeyed with zero mean.

Depending on the specific application scenario, any of the above two RSSI distance models can be applied as appropriate. However, those skilled in the art would appreciate that with any of the above two RSSI distance models, the estimation accuracy of the first position might still not be satisfying.

In order to improve estimation accuracy, in some embodiments an established probabilistic sensor model 412 may be introduced into the position determination module 41 to produce a modified signal strength data, which may be used as an input for the RSSI distance model 411. That is, the established probabilistic sensor model 412 would be placed before the RSSI distance model 411.

The probabilistic sensor model 412 may be established in advance, which defines a probability distribution of signal strength data across the environment.

Just as an example, the probabilistic sensor model 412 may be formulated as below.

$$p ( z \vert x , {l}_{g} ) = p ( s \vert j , δ ( x , {l}_{g} ) ) p ( j \vert δ ( x , {l}_{g} ) ) \qquad ( 3 )$$

where p (z|x, l_{g}) specifies the likelihood of obtaining an observation z given the pose x=(x, y, z) of the antenna and the location l_{g}=(x_{g}, y_{g}) of the detected tag with unique ID g; z=(g, s) indicates two pieces of information, namely the tag g and the received signal strength data s; δ(x, l_{g}) is a position relative to the transmitting antenna; and j is a binary variable that encodes the detection of a certain tag.

Therefore, the above probabilistic sensor model 412 shapes the likelihood of an observation z as the likelihood of the receiving signal strength s at a position δ(x, l_{g}) relative to the tag multiplied by the probability of detecting the tag at this relative position.

With the above probabilistic sensor model 412, those skilled in the art would appreciate that it defines a probability distribution of signal strength data across the environment and thus the above probabilistic sensor model 412 may be used to derive a modified signal strength data based on the probability related to the measured signal strength data from the RFID reader. Further, the modified signal strength data may be used as an input for a RSSI distance model 411 to derive a first position of the robot.

As an example, using the above probabilistic sensor model 412 to derive a modified signal strength data may be implemented by calculating a root sum squared (RSS) mean value based on the signal strength data received from one or more RFID tags within a set time period (Note: the RSS mean value is labelled as

$${rss}_{( 1 ⋯ n )}^{RFID}$$

In FIG. 3, which indicates the n RSS mean values detected from n tags with a set time interval), then using the established probabilistic sensor model to obtain a probability p related to said RSS mean value, and multiplying the RSS mean value with the probability p to derive the modified signal strength data

$$( i . e . , {rss}_{( 1 ⋯ n )}^{RFID} \cdot p ) .$$

Thereafter, the modified signal strength data

$$( i . e . , {rss}_{( 1 ⋯ n )}^{RFID} \cdot p )$$

may be input into a RSSI distance model 411 to derive a first position P_{RFID} of the robot.

As mentioned above, in some embodiments, an IMU 21 may be comprised by the robot to detect inertial data of the robot. As shown in FIG. 3, inertial data (e.g., α, ω, θ) from accelerometers, gyroscopes and magnetometers of IMU 21 may be collected by the controller 4 for further processing.

In some embodiments, the controller 4 may comprise an inertial data estimation module 413 configured to estimate a second position Pₑ, a first velocity vₑ, and a first orientation Aₑ of the robot based on the inertial data from the IMU 21. In some embodiments, the controller 4 may further comprise an error correction module 414 configured to derive a corrected first velocity

$${v}_{e}^{′}$$

of the robot by compensating an acceleration error, and derive a corrected angular rate ω′ of the robot by compensating an angular rate error, wherein the acceleration error may be determined by applying a zero acceleration and a zero velocity to said robot, while the angular rate error may be determined by applying a zero angular rate to the robot. In some embodiments, the error correction module 414 may comprise an error calculating module 418 for determine the error of the inertial data.

In some embodiments, an estimation bias (e.g., a Kalman bias originated from a Kalman Filter) may be determined by a data fusing engine 415 (which will be described below) and then fed back to the inertial data estimation module 413 to compensate the measurement bias of the IMU 21.

In some embodiments, a wheel odometry unit 22 may be comprised by the robot to detect wheel odometry data including e.g., a velocity information v_{w} and a pose information PO_{w} (including position P_{w} and orientation A_{w}) of the robot.

In order to take the respective advantage of the various sensors, the above different kinds of information may be leveraged. For example, in the scenario that the mobile robot is prone to skid, the motion angle in the pose information measured by the wheel odometry unit 22 may be ignored, as the angular rate w measured by the IMU 21 provides a more accurate measurement.

Typically, in the present disclosure, a data fusing engine 415 is used to leverage or fuse the different kinds of information received from the various sensors. For example, the data fusing engine 415 may be configured to determine a calibrated velocity and/or pose information (e.g., a calibrated velocity v_{cal}, a calibrated position P_{cal} and/or a calibrated orientation A_{cal}) for the robot based on measurements from two or more sensors including but not limited to the above mentioned RFID reader 3, IMU 21 and wheel odometry unit 22.

Just as examples, in some embodiments, the data fusing engine 415 may be configured to determine a calibrated position P_{cal} of the robot based on the first positon P_{RFID} estimated from the measurements of the RFID reader 3 and the second position Pₑ estimated from the measurements of the IMU 21. In some embodiments, the data fusing engine 415 may be configured to determine the calibrated position P_{cal} of the robot based on the first positon P_{RFID} estimated from the measurements of the RFID reader 3, the second position Pₑ estimated from the measurements of the IMU 21 and the wheel odometry data from the wheel odometry unit 22.

In some embodiments, the data fusing engine 415 may be configured to derive a calibrated velocity v_{cal} based on the first velocity vₑ or

$${v}_{e}^{′}$$

and the velocity information v_{w} from the wheel odometry unit, and/or derive a calibrated orientation A_{cal} based on the first orientation Aₑ and the pose information PO_{w} from the wheel odometry unit.

In accordance with the present disclosure, the data fusing engine 415 may adopt various data fusing algorithms in the art. As an example, the data fusing engine 415 may comprise any one selected from a group comprising a Kalman Filter (KF) and its more complex versions, e.g., an Extended Kalman Filter (EKF), a Complementary Kalman Fitler, and an Error-state Extended Kalman Filter (ES-EKF). As shown in FIG. 3, an EKF is comprised in the data fusing engine 415.

In additional, it is noted that the various measurement data from the various sensors may be firstly filtered by the data fusing engine 415 to reduce the noise and then for further processing (e.g., fusing). As an example, the noise of the inertial data from IMU may be filtered through an EKF-pose update algorithm, which may obtain a filtered velocity, a displacement and a real-time position for the robot.

It is further noted that although the working principle of the robot system according to the present disclosure is described mainly with respect to FIG. 3, different components of the robot system are possible. For example, in some scenarios, the sensors associated with the robot may comprise merely the RFID reader. In some scenarios, the sensors associated with the robot may comprise merely the RFID reader and one of the IMU and the wheel odometry unit. In addition, in some scenarios, the error correction module 414 might be omitted.

For better understanding of the processing of the controller, FIG. 4 illustrates a flowchart of a method 400 for positioning a mobile robot in an environment according to one embodiment of the present disclosure.

In accordance with the present disclosure, the environment may be arranged with a plurality of RFID tags. For example, in order to facilitate the positioning of the mobile robot, in some embodiments, the plurality of RFID tags may be evenly distributed across the environment. In some embodiments, the plurality of RFID tags may be arranged in a grid pattern. In some embodiments, these RFID tags may for example be attached to a ground, a pillar, a wall, a furniture etc. in the environment.

In some embodiments, UHF RFID tags may be arranged, each of which may be detected in a longer distance, e.g., larger than 1 m.

As shown in FIG. 4, the method 400 may comprise: at block 410, receiving one or more RF signals from at least one RFID tag among the plurality of RFID tags via a RFID reader arranged on the mobile robot.

In some embodiments, the RFID reader 3 may be wiredly or wirelessly connected to a controller 4, which may be integrated or associated with the robot 2, and configured to control the movement of the robot 2 and the RFID reader 3. Typically, the information obtained via the RFID reader 3 may be transmitted to the controller 4 for further processing, e.g., localization or positioning of the robot 2 in the environment.

At block 420, estimating a first position of the robot in the environment based on the received one or more RF signals.

In some embodiments, the estimating a first position of the robot in the environment based on the received one or more RF signals may comprise estimating the first position based on the signal strength data of said one or more RF signals.

In some embodiments, the estimating the first position based on the signal strength data of said one or more RF signals may comprise: using an established probabilistic sensor model to derive a modified signal strength data, wherein the established probabilistic sensor model defines a probability distribution of signal strength data across the environment; and estimating the first position based on the modified signal strength data.

In some embodiments, the using an established probabilistic sensor model to derive a modified signal strength data may comprise: calculating a RSS mean value based on the signal strength data received within a set time period; using the established probabilistic sensor model to obtain a probability related to said RSS mean value; and multiplying the RSS mean value with the probability to derive the modified signal strength data.

Typically, the signal strength data is the received signal strength indicator (RSSI) data.

At block 430, obtaining inertial data from an inertial measurement unit (IMU) arranged on the robot.

Typically, the IMU may be a multi-axis IMU, e.g., a 9-axis IMU, which may comprise one or more accelerometers, one or more gyroscopes, and one or more optional magnetometers to measure inertial data including an acceleration, an angular rate and optional magnetic data. The inertial data may be communicated to the controller 4 for further possessing, e.g., estimating the position, velocity, and orientation of the robot.

In some embodiments, the obtaining inertial data from an inertial measurement unit (IMU) arranged on the robot may comprise: deriving a corrected first velocity of the robot by compensating an acceleration error, which is determined by applying a zero acceleration and a zero velocity to the robot; and deriving a corrected angular rate of the robot by compensating an angular rate error, which is determined by applying a zero angular rate to the robot.

At block 440, estimating a second position of the robot based the inertial data.

In some embodiments, the estimating a second position of the robot based the inertial data may be implemented by integrating twice the acceleration obtained from the IMU.

In some embodiments, estimation bias (e.g., a Kalman bias originated from a Kalman Filter) may be determined by a data fusing engine 415 and then fed back to the inertial data estimation module 413 to compensate the measurement bias of the IMU, so as to improve the estimation of the second position of the robot.

At block 450, determining a calibrated position of the robot based on the first positon and the second position.

In some embodiments, the determining the calibrated position of the robot is performed by a data fusing engine. In some embodiments, the data fusing engine may be characterized by any one selected from a group comprising a Kalman Filter (KF), an Extended Kalman Filter (EKF), a Complementary Kalman Filter, and an Error-state Extended Kalman Filter (ES-EKF).

In some embodiments, the determining the calibrated position of the robot may comprise: deriving the calibrated position of the robot based on the first positon, the second position and the wheel odometry data, which may be obtained from a wheel odometry unit integrated with the robot, the wheel odometry data including a velocity information and a pose information of the robot.

In addition to the above blocks, the method 400 may further comprise: estimating a first velocity and a first orientation of the robot in the environment based on said inertial data; determining a calibrated velocity based on the first velocity and the velocity information from the wheel odometry unit, and determining a calibrated orientation based on the first orientation and the pose information from the wheel odometry unit.

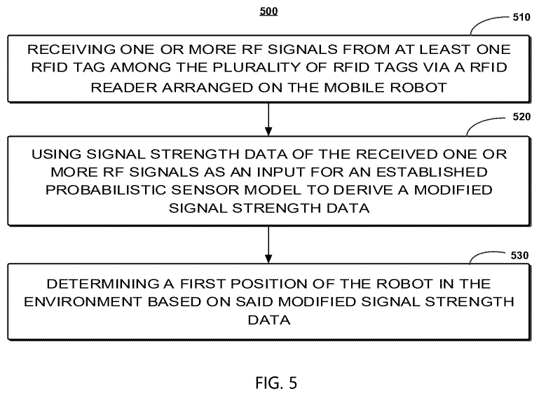

FIG. 5 illustrates a flowchart of a method 500 for positioning a mobile robot in an environment according to another embodiment of the present disclosure.

It is noted that in this method 500, emphasis is placed upon the use of the established probabilistic sensor model to determine the first position of the robot. In some scenarios, the first position determined in this manner may be directly used for positioning the robot.

As shown in FIG. 5, the method 500 may comprise: at block 510, receiving one or more RF signals from at least one RFID tag among the plurality of RFID tags via a RFID reader arranged on the mobile robot.

At block 510, using signal strength data of the received one or more RF signals as an input for an established probabilistic sensor model to derive a modified signal strength data, wherein the established probabilistic sensor model defines a probability distribution of signal strength data across the environment.

In accordance with the present disclosure, the probabilistic sensor model 412 may be established in advance. In some embodiments, the probabilistic sensor model may formulate the likelihood of an observation as the likelihood of receiving signal strength s at a position δ(x, l_{g}) relative to the detected tag multiplied by the probability of detecting the tag at this relative position.

In some embodiments, the using the signal strength data of the received one or more RF signals as an input for an established probabilistic sensor model to derive a modified signal strength data may comprise: obtaining a probability related to the signal strength data of the received one or more RF signals; and deriving the modified signal strength data by multiplying the signal strength data with the probability.

At block 530, determining a first position of the robot in the environment based on said modified signal strength data.

In some embodiments, the determining a first position of the robot in the environment based on said modified signal strength data may comprise: using the modified signal strength data as an input for a RSSI distance model to derive the first position.

In addition to the above blocks, the method 500 may further comprise: determining a calculated position of the robot by fusing the obtained first position with other measurement data obtained from other sensors, e.g., an IMU or a wheel odometry unit.

For example, in some embodiment, the determining a calculated position of the robot may comprise: determining a calibrated position of the robot based on the first positon and a second position obtained from the IMU or the wheel odometry unit. In some embodiments, the determining a calculated position of the robot may comprise: determining a calibrated position of the robot based on the first positon, a second position obtained from the IMU and a third position from the wheel odometry unit.

Various embodiments with respect to the method for positioning the mobile robot and the associated robot system have been described above. With the above description, those skilled in the art would appreciate that with the aid of a plurality of RFID tags arranged in the environment, even some of the RFID tags are blocked (e.g., by a customer) from detection by the RFID reader, the robot may still implement the positioning of the robot by detecting the other unblocked tags, and the working or moving will not be interrupted. As a result, as compared to the conventional laser-based navigation method, the positioning method and system in the present disclosure can reduce the risk of failed localization due to blocked identification, and improve the stability, reliability and efficiency of the positioning.

In accordance with the present disclosure, there is also provided a computer readable storage medium having instructions stored thereon which, when executed by a processor or a controller, may implement the method as described above.

In some embodiments, the computer readable storage medium may include but not be limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Various implementations of the present disclosure have been described in detail above. It should be noted that these various implementations of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

In addition, although the above method is described with steps in sequence. The order of the steps in the method may be changed, reordered, combined, omitted, modified, etc., as appropriate for different application scenarios. In addition, functions in different modules or blocks in a block diagram can be integrated in one same module or block, or a function in one module or block can be implemented in two or more discrete modules or blocks.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method for positioning a mobile robot in an environment, in which a plurality of RFID tags are arranged, the method comprising:
receiving one or more RF signals from at least one RFID tag among the plurality of RFID tags via a RFID reader arranged on the mobile robot;
estimating a first position of the robot in the environment based on the received one or more RF signals;
obtaining inertial data from an inertial measurement unit (IMU) arranged on the robot;
estimating a second position of the robot based the inertial data; and
determining a calibrated position of the robot based on the first positon and the second position.

2. The method of claim 1, further comprising:
obtaining wheel odometry data from a wheel odometry unit integrated with the robot, the wheel odometry data including a velocity information and a pose information of the robot.

3. The method of claim 2, wherein the determining the calibrated position of the robot comprises:
determining the calibrated position of the robot based on the first position, the second position and the wheel odometry data.

4. The method of claim 2, further comprising:
estimating a first velocity and a first orientation of the robot in the environment based on said inertial data;
determining a calibrated velocity based on the first velocity and the velocity information; and
determining a calibrated orientation based on the first orientation and the pose information.

5. The method of claim 1, wherein the obtaining inertial data from an inertial measurement unit (IMU) arranged on the robot comprises:
deriving a corrected first velocity of the robot by compensating an acceleration error, which is determined by applying a zero acceleration and a zero velocity to the robot; and
deriving a corrected angular rate of the robot by compensating an angular rate error, which is determined by applying a zero angular rate to the robot.

6. The method of claim 1, wherein the determining the calibrated position of the robot is performed by a data fusing engine.

7. The method of claim 6, wherein the data fusing engine comprises any one selected from a group comprising a Kalman Filter (KF), an Extended Kalman Filter (EKF), a Complementary Kalman Filter, and an Error-state Extended Kalman Filter (ES-EKF).

8. The method of claim 1, wherein the estimating a first position of the robot in the environment comprises:
estimating the first position based on the signal strength data of the received one or more RF signals.

9. The method of any of claim 8, wherein the estimating the first position based on the signal strength data of the received one or more RF signals comprises:
using an established probabilistic sensor model to derive a modified signal strength data, wherein the established probabilistic sensor model defines a probability distribution of signal strength data across the environment; and
estimating the first position based on the modified signal strength data.

10. The method of claim 9, wherein the using an established probabilistic sensor model to derive a modified signal strength data comprises:
calculating a RSS mean value based on the signal strength data received within a set time period;
using the established probabilistic sensor model to obtain a probability related to said RSS mean value; and
multiplying the RSS mean value with the probability to derive the modified signal strength data.

11. The method of claim 8, wherein the estimating the first position based on the modified signal strength data comprises:
using the modified signal strength data as an input for a RSSI distance model to derive the first position.

12. The method of claim 1, wherein the RFID tags are ultra high frequency (UHF) passive RFID tags.

13. The method of claim 1, wherein the plurality of RFID tags are arranged in an array or a grid pattern.

14. The method of claim 1, wherein the plurality of RFID tags are evenly distributed across the environment.

15. A mobile robot system comprising:
a mobile robot having an inertial measurement unit (IMU) and configured to move in an environment provided with a plurality of RFID tags;
a RFID reader arranged on the robot; and
a controller integrated or associated with the robot, wherein the controller is configured to:
receive one or more RF signals from at least one RFID tag among the plurality of RFID tags via the RFID reader;
estimate a first position of the robot in the environment based on the received one or more RF signals;
obtain inertial data from the inertial measurement unit (IMU);
estimate a second position of the robot based on the inertial data; and
determine a calibrated position of the robot based on the first positon position and the second position.

16. A method for positioning a mobile robot in an environment, in which a plurality of RFID tags are arranged, the method comprising:
receiving one or more RF signals from at least one RFID tag among the plurality of RFID tags via a RFID reader arranged on the mobile robot;
using signal strength data of the received one or more RF signals as an input for an established probabilistic sensor model to derive a modified signal strength data, wherein the established probabilistic sensor model defines a probability distribution of signal strength data across the environment; and
determining a first position of the robot in the environment based on said modified signal strength data.

17. The method of claim 16, wherein the using the signal strength data of the received one or more RF signals as an input for an established probabilistic sensor model to derive a modified signal strength data comprises:
obtaining a probability related to the signal strength data of the received one or more RF signals; and
deriving the modified signal strength data by multiplying the signal strength data with the probability.

18. The method of claim 17, the determining a first position of the robot in the environment based on said modified signal strength data comprises:
using the modified signal strength data as an input for a RSSI distance model to derive the first position.

19. A robot system comprising:
a robot having an inertial measurement unit (IMU) and configured to move in an environment provided with a plurality of RFID tags;
a RFID reader arranged on the robot; and
a controller integrated or associated with the robot, wherein the controller is configured to;
receive one or more RF signals from at least one RFID tag among the plurality of RFID tags via a RFID reader arranged on the mobile robot;
use signal strength data of the received one or more RF signals as an input for an established probabilistic sensor model to derive a modified signal strength data, wherein the established probabilistic sensor model defines a probability distribution of signal strength data across the environment; and
determine a first position of the robot in the environment based on said modified signal strength data.

20. A non-transitory computer readable medium having a computer program stored thereon which, when executed by a processor, implements the method of claim 1.
